(19) United States
(12) Patent Application Publication
(10) Pub. No.: US 2008/0122371 A1
(43) Pub. Date: May 29, 2008

(54) Method of controlling a passive matrix arrangement of organic light emitting diodes

(76) Inventors: Uwe Vogel, Dresden (DE); Peter Koenig, Dresden (DE); Bernd Richter, Bautzen (DE); Gerd Bunk, Dresden (DE)

Correspondence Address: JACOBSON HOLMAN PLLC, 400 SEVENTH STREET N.W., SUITE 600, WASHINGTON, DC, 20004, US

(21) Appl. No.: 11/819,055

(22) Filed: Jun. 25, 2007

(30) Foreign Application Priority Data
Jun. 23, 2006 (DE) 10 2006 030 539.5

(51) Int. Cl. G09G 3/10

(52) U.S. Cl. 315/169.3

(57) ABSTRACT

The invention relates to a method of controlling a passive matrix arrangement of organic light emitting diodes which can be used, for example, as a display for the rendering or display of visually perceivable information. It is the object of the invention to increase the service life of passive matrix arrangements with organic light emitting diodes with an increased presettable luminance of electromagnetic radiation emitted by organic light emitting diodes. In the method in accordance with the invention, the electrical current flow takes place via rows and lines of a passive matrix arrangement of organic light emitting diodes connected to an electrical power source. The electrical current flow is modulated in its pulse width, that is the respective switch-on time, to be able to observe presettable luminance values of the individual organic light emitting diodes. Larger pulse width/longer switch-on times thus result in a larger luminance of the emitted electromagnetic radiation. The electrical current flow is influenced over the individual rows such that the switch-on procedures are carried out at rows of the matrix arrangement offset in time. The switching on of the electrical current flow accordingly takes place over rows of the matrix arrangement at different points in time.

The invention relates to a method of controlling a passive matrix arrangement of organic light emitting diodes which can be used, for example, as a display for the rendering or display of visually perceivable information.

The advantageous properties of organic light emitting diodes can be utilized in this context. The invention can be used particularly advantageously in organic light emitting diodes also transparent for electromagnetic radiation. It can also be used in arrangements of organic light emitting diodes emitting electromagnetic radiation at two sides.

In addition to active matrix arrangements, however, passive matrix arrangements are more frequently chosen since they are technologically easier to control. However, these show a lower resolution with respect to the active ones since the increased electrical current flow required for a higher resolution shortens the service life of organic light emitting diodes. With transparent embodiments, the electrical resistance of the electrodes is also a limiting parameter.

With passive matrix arrangements, the respective luminance at which electromagnetic radiation is emitted by organic light emitting diodes is usually influenced by modulation of the electrical current flowing over rows and lines of the matrix arrangement. In this connection, a modulation of the amplitude and/or of the pulse width (time period of the electrical current flow) can be carried out. On a switch-on procedure, an increased electrical current is briefly selected to achieve a precharge. The respective luminance is substantially influenced by the switch-on period of an organic luminance.

In the known passive matrix arrangements, the electrical current flowing over individual lines is limited by the maximum permitted voltage drop of the respective line and by the electrical resistance of the conductor tracks. This also has the consequence that the maximum number of controllable rows and lines is limited with predetermined luminance values to be reached.

The respective maximum electrical current density also influences the transparency of organic light emitting diodes. In this connection, the transparency is larger with smaller maximum electrical current density.

As already indicated, the achievable service life of organic light emitting diodes is influenced by the maximum flowing electrical currents. The correspondingly higher electrical currents in particular result in a shortening of the service life in matrix arrangements with a high resolution.

It is therefore the object of the invention to increase the service life of passive matrix arrangements with organic light emitting diodes with an increased presettable luminance of electromagnetic radiation emitted by organic light emitting diodes.

This object is solved in accordance with the invention by a method having the features of claim 1. Advantageous aspects and further developments can be achieved using features designated in the subordinate claims.

In the method in accordance with the invention, the electrical current flow takes place via rows and lines of a passive matrix arrangement of organic light emitting diodes connected to an electrical power source. The electrical current flow is modulated in its pulse width, that is the respective switch-on time, to be able to observe presettable luminance values of the individual organic light emitting diodes. Larger pulse width/longer switch-on times thus result in a larger luminance of the emitted electromagnetic radiation.

In accordance with the invention, the electrical current flow is influenced over the individual rows such that the switch-on procedures are carried out offset in time at rows of the matrix arrangement. The switching on of the electrical current flow accordingly takes place over rows of the matrix arrangement at different points in time. Different regimes can be selected for this purpose which take account e.g. of the maximum desired luminance, the number of rows and lines of a matrix arrangement or also whether it is a transparent embodiment or not.

The electrical current flow can also be switched on simultaneously at some rows. However, this takes place offset in time at some rows.

The possibility thus exists of switching the electrical current on and off alternately at rows respectively arranged adjacent to one another. It is thus possible to work with inverse pulse width modulation. Assuming that the mean luminance values lie at approx. 50% of the maximum value, the electrical flow which flows over the lines can be distributed better over the time available with an activated line. The maximum electrical current flowing over the lines and the electrical losses can thereby advantageously be reduced.

On switching on, an increased electrical current (precharge) can also flow briefly in the invention, as is also the case with conventional solutions. The electrical current flowing over the rows is not limited or is less limited by the electrical power source. A charging of parasitic parallel capacities takes place by an electrical power source having an internal resistance which is as small as possible. A large electrical current flows over all activated rows. On a simultaneous switch-on of the electrical current flow at the rows, the increased electrical current would be applied simultaneously, which would in turn result in a much increased electrical current flowing over lines with a correspondingly increased voltage drop over an electrical supply line. Due to this, however, the necessary time is also extended in which an increased electrical current is required at the start of a switch-on (“charging” of organic light emitting diodes).

If, however, one proceeds in accordance with the invention, this can be avoided since times in which increased electrical current flows over rows and lines are spread out and the simultaneously flowing total electrical current and maximum current can thus be reduced.

In an alternative, however, influence can also be taken such that the electrical current flow at rows is successively switched on. In this connection, a start can be made with a first row and then a respectively adjacently arranged row can be switched on equidistantly in time or also with different time intervals. This can be carried out over all existing rows up to a last row.

However, rows can also be combined into groups which are then operated in the group. The number of rows and lines present on a matrix arrangement and also a frame refresh rate/frame rate can be taken into account in this process.

When controlling a passive matrix arrangement, it is also possible to proceed such that the switch-on period of a line is influenced while taking account of a maximum luminance, the electromagnetic radiation to be emitted by an organic light emitting diode arranged in the line, to be achieved.

Switch-on points in time at rows of a matrix arrangement can, however, be selected by the respective instantaneous luminance distribution at organic light emitting diodes over the total surface or presettable surface regions of the matrix arrangement.

A control can take place such that times are minimized??? in which no electrical current, or only a small electrical current, flows over lines for the reduction of the maximum flowing electrical currents and for the avoidance of a limitation by high electrical resistances of the lines. In this connection, the activation of a line (line phase) can be carried out while taking account of the maximum luminance of one or more organic light emitting diodes in the respective line. The possibility exists for this purpose to carry out an extension of the switch-on time (pulse width) scaled to the respective organic light emitting diode at a constant frame refresh rate and thereby likewise to reduce the maximum flowing electrical current (peak current).

Increased luminance values can be achieved with the invention with a reduced electrical power loss at passive matrix arrangement with organic light emitting diodes.

The resolution can be improved by an increased number of rows, lines and organic light emitting diodes.

A lower electrical voltage is also required since the electrical voltage drop over the electrical conductors of the lines can likewise be reduced, as also applies to the required electrical power.

The line width of the electrical conductors in the lines can likewise be reduced with a predetermined luminance. The transparency can likewise be improved with comparable achievable luminance values over conventional solutions since conductor tracks can be made thinner.

The invention will be explained in more detail by way of example in the following.

There are shown:

FIG. 1: the electrical current flow over rows of a passive matrix arrangement according to the prior art and according to the invention in a comparative presentation;

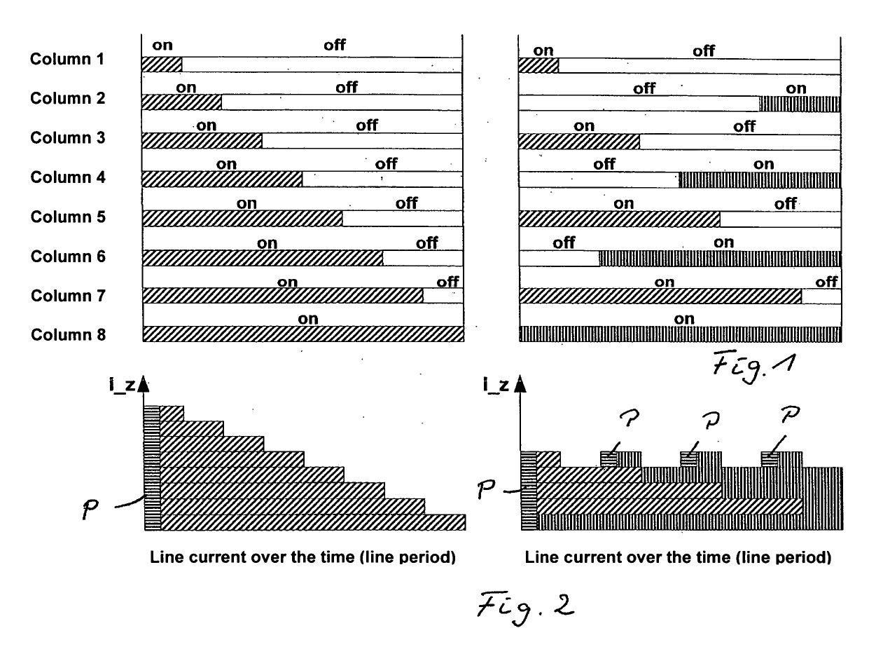

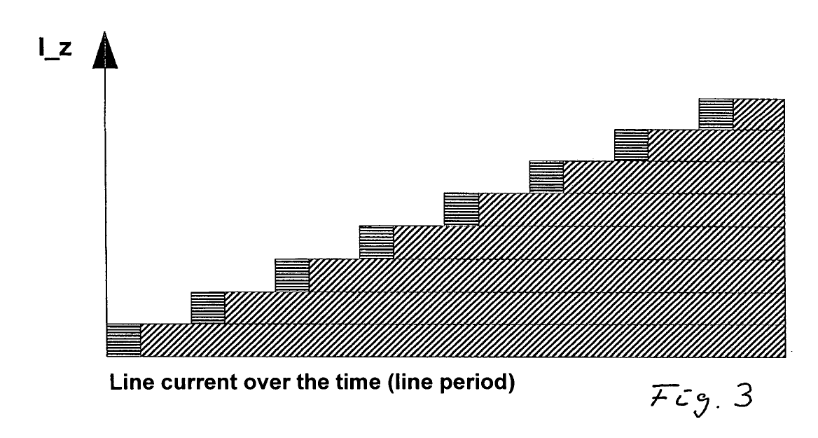

FIG. 2: the electrical current flow over lines of a passive matrix arrangement according to the prior art and according to the invention in a comparative presentation; and

FIG. 3: the electrical current flow in lines with a switch-on at rows offset in time.

In FIG. 1, a possibility is shown on the left for the control of passive matrix arrangements in accordance with the prior art and a possible procedure in accordance with the invention on the right.

It is made clear by the left hand representation that electrical current flows simultaneously through all rows 1 to 8 of a passive matrix arrangement, which is indicated by bars underlaid in black. In this connection, a different switch-on period (pulse width) has been selected in the individual rows during which the electrical current flows over the respective rows. The time phase (precharge) during which increased electrical current flows is, however, always the same so that this higher electrical current also flows simultaneously in the lines, which can be seen from the left hand representation of FIG. 2 marked by “P”. A very high maximum electrical current flow can thus be recorded at least at times.

In the right hand representation of FIG. 2, the control is operated “inversely”. In this connection, the switching on of electrical current takes place at odd-numbered rows at the same points in time and the switching on of electrical current takes place at even-numbered rows arranged adjacent thereto offset in time thereto so that their switching on takes place at points in time when no electrical current flows, but at least not the increased electrical current on the switch-on of the respective row, in an adjacent row, which can be seen from the right hand representation of FIG. 2 for the electrical current flowing over the lines. It can likewise be seen from this that the respective flowing maximum electrical current can likewise be reduced.

The increased electrical current flow for a precharge of organic light emitting diodes in lines offset in time, spread over the time and marked in each case by “P” can be seen from the representation in accordance with FIG. 3.

1. A method of controlling a passive matrix arrangement of organic light emitting diodes, wherein the organic light emitting diodes are connected with a row and line arrangement to at least one electrical power source and the luminance of electromagnetic radiation emitted by individual organic light emitting diodes is influenced by modulation of the pulse width of the electrical current;
with the electrical current flowing over the rows of organic light emitting diodes and the lines of organic light emitting diodes; and
the switch-on procedures of the electrical current flow being carried out at the rows of the matrix arrangement offset in time.

2. A method in accordance with claim 1, characterized in that the electrical current is switched on and off alternatingly at adjacently arranged rows of organic light emitting diodes.

3. A method in accordance with claim 1, characterized in that an increased electrical current flows at the start of the switching on of the electrical current.

4. A method in accordance with claim 1, characterized in that the switching on is carried out successively at the rows of the matrix arrangement.

5. A method in accordance with claim 4, characterized in that the switch-on procedures are initiated starting from a first row up to a last row at respectively the same time interval.

6. A method in accordance with claim 1, characterized in that, while electrical current flows over a respective line, the electrical current supplied via the rows is controlled such that the times at which an increased electrical current flows on the switching on are spread over the switch-on phase of the respective line.

7. A method in accordance with claim 1, characterized in that the switch-on period of a respective line is determined while taking account of the respective maximum luminance to be achieved by an organic light emitting diode arranged in the row.

8. A method in accordance with claim 1, characterized in that the switch-on points in time at rows of the matrix arrangement are controlled while taking account of the instantaneous luminance distribution of the organic light emitting diodes over the surface of the matrix arrangement.
